(19) United States
(12) Patent Application Publication
(10) Pub. No.: US 2024/0214927 A1
(43) Pub. Date: Jun. 27, 2024

(54) TECHNIQUES FOR PROVIDING A SLOT LEVEL CONTROL PLANE RADIO FREQUENCY CHANNEL RECONFIGURATION COMMAND

(71) Applicant: QUALCOMM Incorporated, San Diego, CA (US)

(72) Inventors: Michael Francis GARYANTES, Bradley Beach, NJ (US); Abhishek Saurabh SACHIDANAND SINHA, San Diego, CA (US); Deepak AGARWAL, San Diego, CA (US)

(21) Appl. No.: 18/522,921

(22) Filed: Nov. 29, 2023

Related U.S. Application Data
(60) Provisional application No. 63/476,773, filed on Dec. 22, 2022.
(60) Provisional application No. 63/491,268, filed on Mar. 20, 2023.
(60) Provisional application No. 63/499,133, filed on Apr. 28, 2023.

(51) Int. Cl. H04W 52/02; H04W 72/0446

(52) U.S. Cl. CPC H04W 52/0206; H04W 72/0446

(57) ABSTRACT

Various aspects of the present disclosure generally relate to wireless communication. In some aspects, a radio unit (RU) may provide, to a distributed unit (DU), capability information associated with at least one antenna element set, the at least one antenna element set comprising a set of antenna elements, of a plurality of antenna elements of the RU, configured for communication while the set of antenna elements is active. The RU may obtain, from the DU, a slot level control plane configuration message comprising a radio frequency (RF) channel reconfiguration command that indicates an antenna element set of the at least one antenna element set. The RU may communicate, based on the RF channel reconfiguration command, a wireless communication using the antenna element set. Numerous other aspects are described.

### CROSS-REFERENCE TO RELATED APPLICATION

This Patent Application claims priority to U.S. Provisional Patent Application No. 63/476,773, filed on Dec. 22, 2022, entitled “TECHNIQUES FOR PROVIDING A SLOT LEVEL CONTROL PLANE RADIO FREQUENCY CHANNEL RECONFIGURATION COMMAND,” U.S. Provisional Patent Application No. 63/491,268, filed on Mar. 20, 2023, entitled “TECHNIQUES FOR PROVIDING A SLOT LEVEL CONTROL PLANE RADIO FREQUENCY CHANNEL RECONFIGURATION COMMAND,” and U.S. Provisional Patent Application No. 63/499,133, filed on Apr. 28, 2023, entitled “TECHNIQUES FOR PROVIDING A SLOT LEVEL CONTROL PLANE RADIO FREQUENCY CHANNEL RECONFIGURATION COMMAND,” each of which is assigned to the assignee hereof. The disclosures of the prior Applications are considered part of and are incorporated by reference into this Patent Application.

### FIELD OF THE DISCLOSURE

Aspects of the present disclosure generally relate to wireless communication and to techniques and apparatuses for providing a slot level control plane radio frequency channel reconfiguration command.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a radio unit (RU) for wireless communication. The method may include providing, to a distributed unit (DU), capability information associated with at least one antenna element set, the at least one antenna element set comprising a set of antenna elements, of a plurality of antenna elements of the RU, configured for communication while the set of antenna elements is active. The method may include obtaining, from the DU, a slot level control plane configuration message comprising a radio frequency (RF) channel reconfiguration command that indicates an antenna element set of the at least one antenna element set. The method may include communicating, based on the RF channel reconfiguration command, a wireless communication using the antenna element set.

Some aspects described herein relate to a method of wireless communication performed by a DU for wireless communication. The method may include obtaining, from an RU, capability information associated with at least one antenna element set, the at least one antenna element set comprising a set of antenna elements, of a plurality of antenna elements of the RU, configured for communication while the set of antenna elements is active. The method may include providing, to the RU, a slot level control plane configuration message comprising an RF channel reconfiguration command that indicates an antenna element set of the at least one antenna element set.

Some aspects described herein relate to an RU for wireless communication. The radio unit may include one or more memories and one or more processors coupled to the one or more memories. The one or more processors may be configured to provide, to a DU, capability information associated with at least one antenna element set, the at least one antenna element set comprising a set of antenna elements, of a plurality of antenna elements of the RU, configured for communication while the set of antenna elements is active. The one or more processors may be configured to obtain, from the DU, a slot level control plane configuration message comprising an RF channel reconfiguration command that indicates an antenna element set of the at least one antenna element set. The one or more processors may be configured to communicate, based on the RF channel reconfiguration command, a wireless communication using the antenna element set.

Some aspects described herein relate to a DU for wireless communication. The distributed unit may include one or more memories and one or more processors coupled to the one or more memories. The one or more processors may be configured to obtain, from an RU, capability information associated with at least one antenna element set, the at least one antenna element set comprising a set of antenna elements, of a plurality of antenna elements of the RU, configured for communication while the set of antenna elements is active. The one or more processors may be configured to provide, to the RU, a slot level control plane configuration message comprising an RF channel reconfiguration command that indicates an antenna element set of the at least one antenna element set.

Some aspects described herein relate to a non-transitory computer-readable medium that stores a set of instructions for wireless communication by an RU. The set of instructions, when executed by one or more processors of the RU, may cause the RU to provide, to a DU, capability information associated with at least one antenna element set, the at least one antenna element set comprising a set of antenna elements, of a plurality of antenna elements of the RU, configured for communication while the set of antenna elements is active. The set of instructions, when executed by one or more processors of the RU, may cause the RU to obtain, from the DU, a slot level control plane configuration message comprising an RF channel reconfiguration command that indicates an antenna element set of the at least one antenna element set. The set of instructions, when executed by one or more processors of the RU, may cause the RU to communicate, based on the RF channel reconfiguration command, a wireless communication using the antenna element set.

Some aspects described herein relate to a non-transitory computer-readable medium that stores a set of instructions for wireless communication by a DU. The set of instructions, when executed by one or more processors of the DU, may cause the DU to obtain, from an RU, capability information associated with at least one antenna element set, the at least one antenna element set comprising a set of antenna elements, of a plurality of antenna elements of the RU, configured for communication while the set of antenna elements is active. The set of instructions, when executed by one or more processors of the DU, may cause the DU to provide, to the RU, a slot level control plane configuration message comprising an RF channel reconfiguration command that indicates an antenna element set of the at least one antenna element set.

Some aspects described herein relate to an apparatus for wireless communication. The apparatus may include means for providing, to a DU, capability information associated with at least one antenna element set, the at least one antenna element set comprising a set of antenna elements, of a plurality of antenna elements of the apparatus, configured for communication while the set of antenna elements is active. The apparatus may include means for obtaining, from the DU, a slot level control plane configuration message comprising an RF channel reconfiguration command that indicates an antenna element set of the at least one antenna element set. The apparatus may include means for communicating, based on the RF channel reconfiguration command, a wireless communication using the antenna element set.

Some aspects described herein relate to an apparatus for wireless communication. The apparatus may include means for obtaining, from an RU, capability information associated with at least one antenna element set, the at least one antenna element set comprising a set of antenna elements, of a plurality of antenna elements of the RU, configured for communication while the set of antenna elements is active. The apparatus may include means for providing, to the RU, a slot level control plane configuration message comprising an RF channel reconfiguration command that indicates an antenna element set of the at least one antenna element set.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIGS. 4A-4D are diagrams illustrating examples associated with providing a slot level control plane radio frequency (RF) channel reconfiguration command, in accordance with the present disclosure.

FIG. 5 is a diagram illustrating an example process performed, for example, by a radio unit (RU), in accordance with the present disclosure.

FIG. 6 is a diagram illustrating an example process performed, for example, by a distributed unit (DU), in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

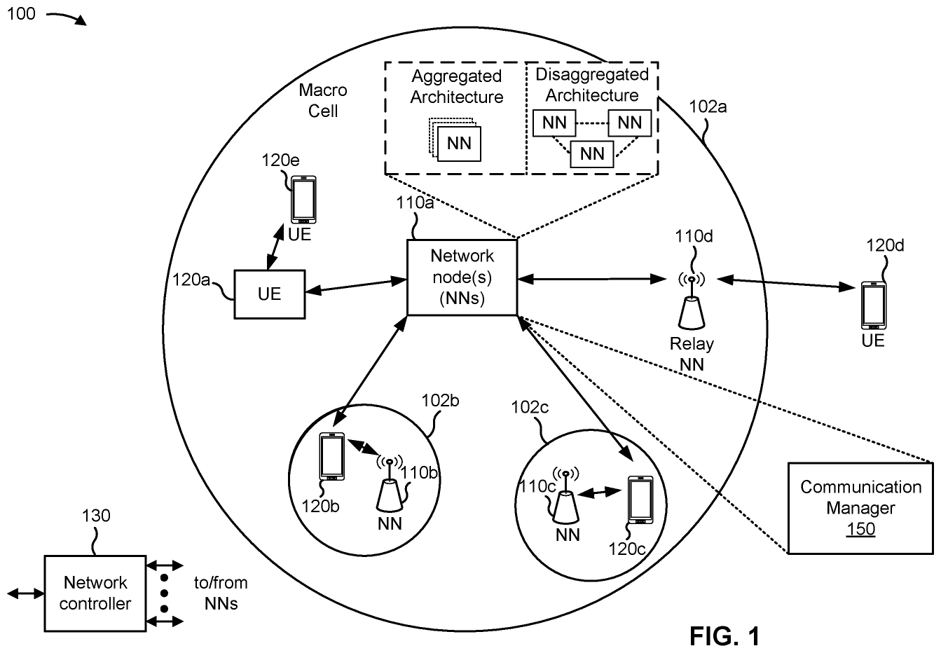

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6

GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a network node 110 may be an RU and may include a communication manager 150. As described in more detail elsewhere herein, the communication manager 150 may provide, to a DU, capability information associated with at least one antenna element set, the at least one antenna element set comprising a set of antenna elements, of a plurality of antenna elements of the RU, configured for communication while the set of antenna elements is active; obtain, from the DU, a slot level control plane configuration message comprising a RF channel reconfiguration command that indicates an antenna element set of the at least one antenna element set; and communicate, based on the RF channel reconfiguration command, a wireless communication using the antenna element set. Additionally, or alternatively, the communication manager 150 may perform one or more other operations described herein.

In some aspects, the network node 110 may be a DU and may include the communication manager 150. As described in more detail elsewhere herein, the communication manager 150 may obtain, from an RU, capability information associated with at least one antenna element set, the at least one antenna element set comprising a set of antenna elements, of a plurality of antenna elements of the RU, configured for communication while the set of antenna elements is active; and provide, to the RU, a slot level control plane configuration message comprising an RF channel reconfiguration command that indicates an antenna element set of the at least one antenna element set. Additionally, or alternatively, the communication manager 150 may perform one or more other operations described herein.

As indicated above, FIG. 1 is provided as an example. Other examples may differ from what is described with regard to FIG. 1.

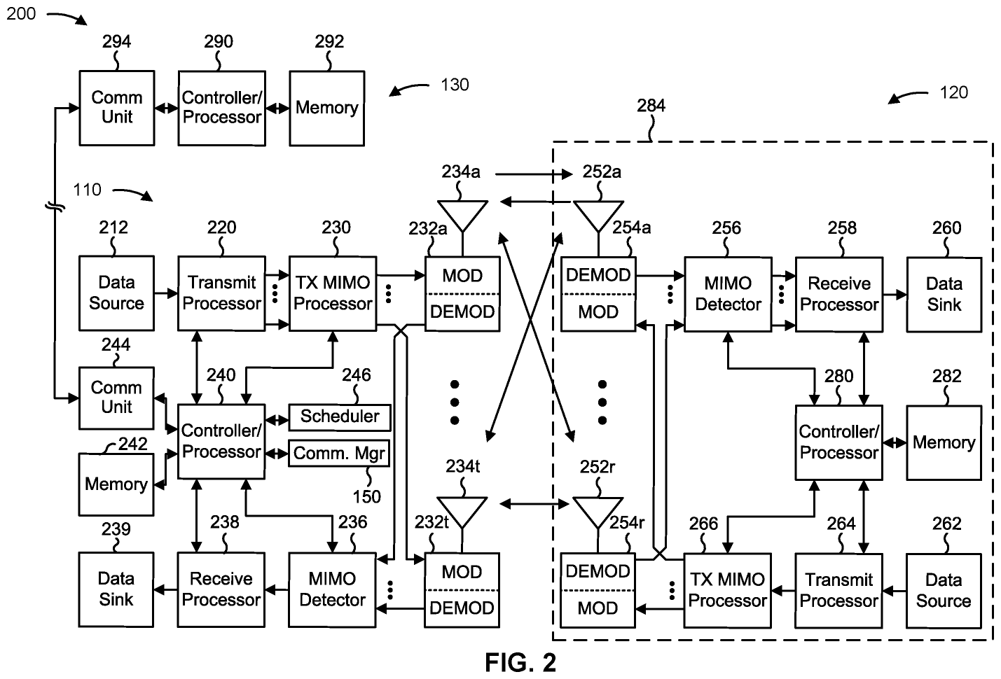

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

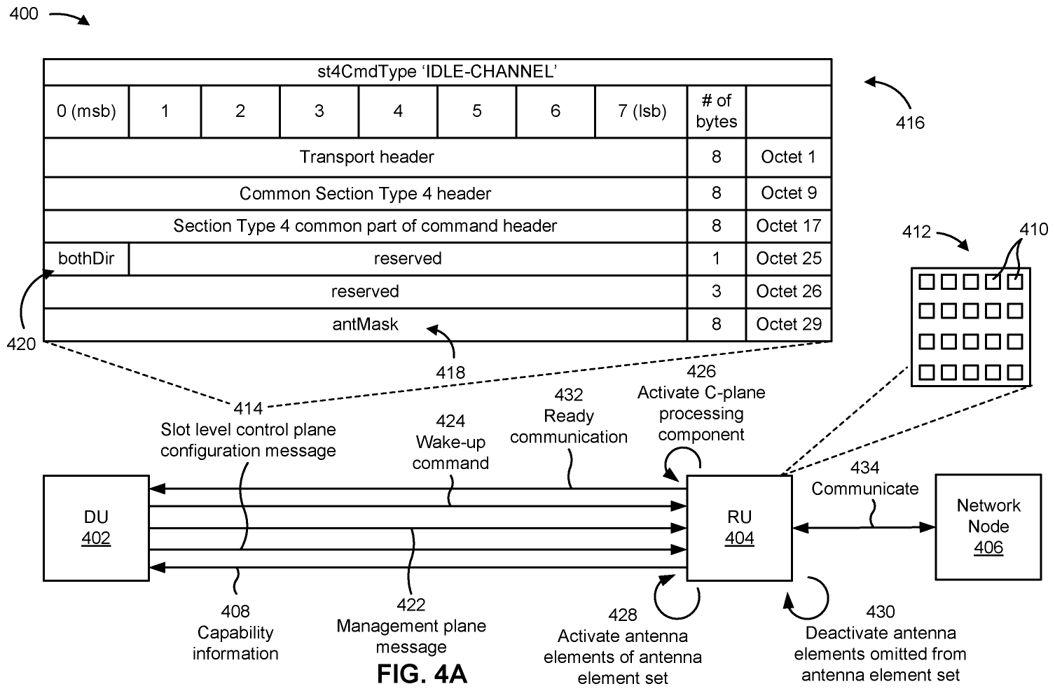

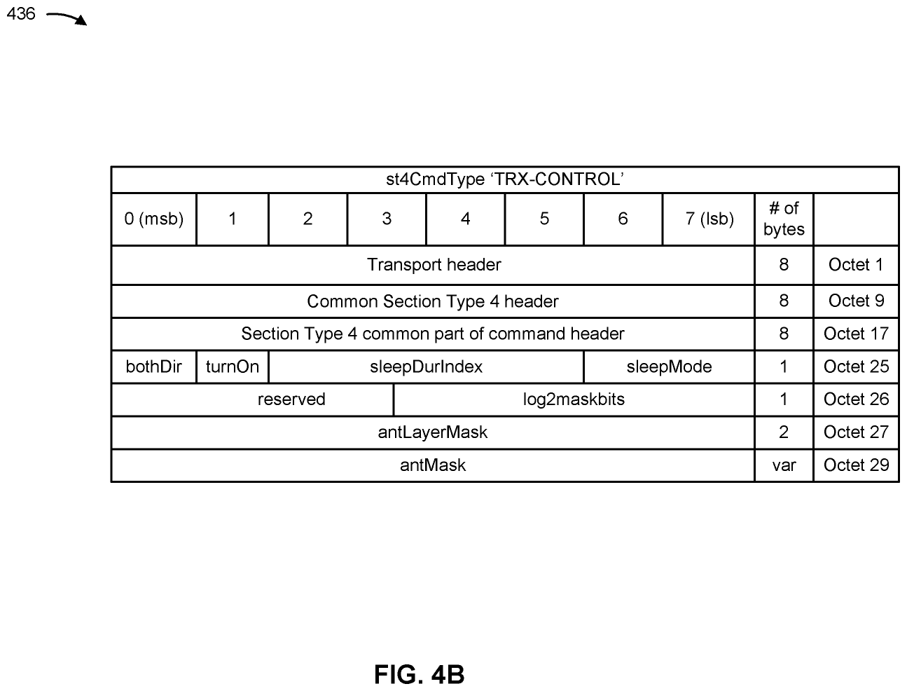

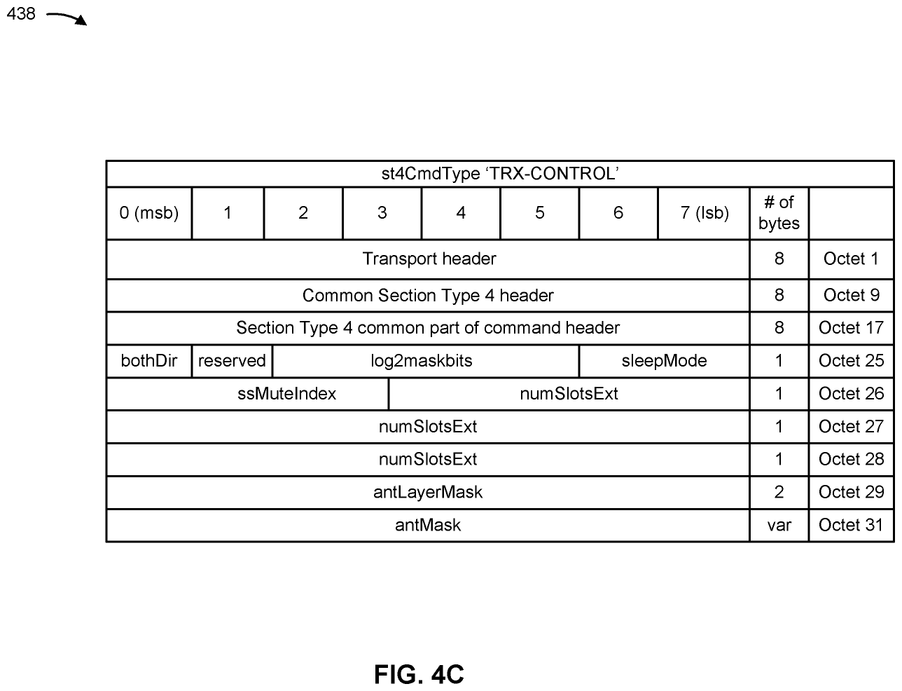

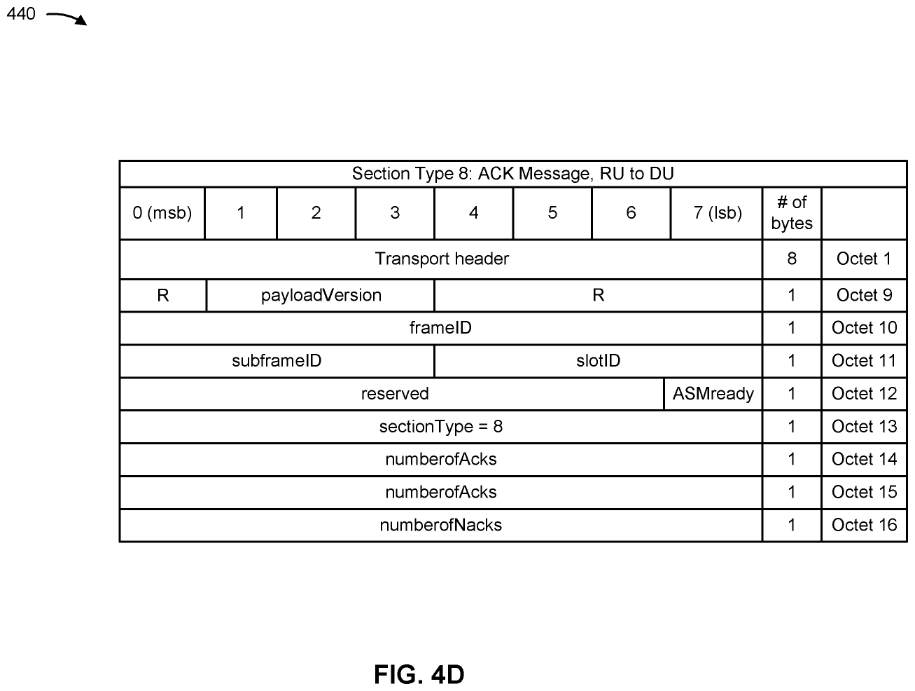

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-7).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-7).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

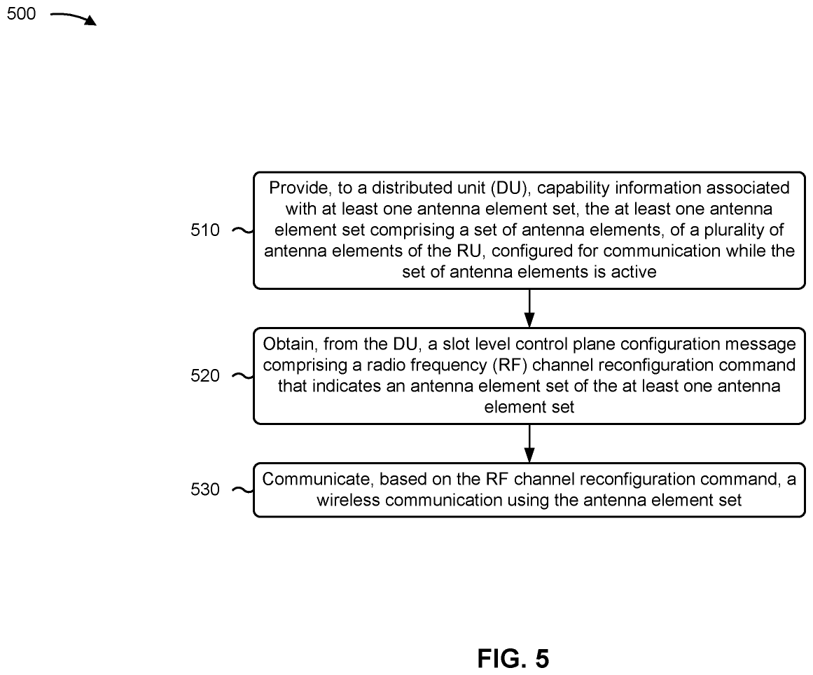

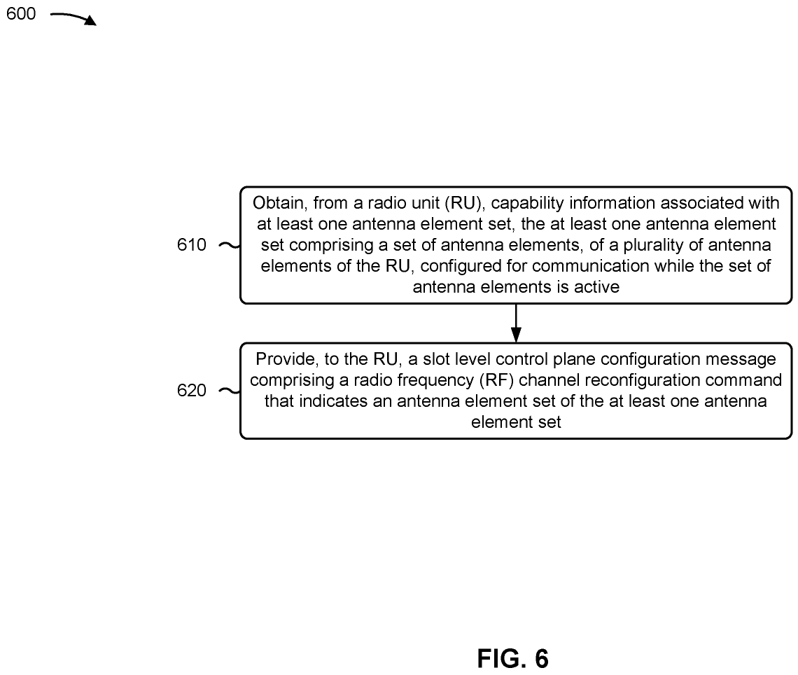

The controller/processor 240 of the network node 110, the controller/processor 280 of the UE 120, or any other component(s) of FIG. 2 may perform one or more techniques associated with providing a slot level control plane RF channel reconfiguration command, as described in more detail elsewhere herein. In some aspects, RU and/or the DU described herein is the network node 110, is included in the network node 110, or includes one or more components of the network node 110 shown in FIG. 2. For example, the controller/processor 240 of the network node 110, the controller/processor 280 of the UE 120, or any other component(s) (or combinations of components) of FIG. 2 may perform or direct operations of, for example, process 500 of FIG. 5, process 600 of FIG. 6, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the one or more instructions, when executed (for example, directly, or after compiling, converting, or interpreting) by one or more processors, individually or collectively, of the network node 110 or the UE 120, may cause the one or more processors, the UE 120, or the network node 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, a network node 110 (e.g., an RU) includes means for providing, to a DU, capability information associated with at least one antenna element set, the at least one antenna element set comprising a set of antenna elements, of a plurality of antenna elements of the RU, configured for communication while the set of antenna elements is active; means for obtaining, from the DU, a slot level control plane configuration message comprising an RF channel reconfiguration command that indicates an antenna element set of the at least one antenna element set; and/or means for communicating, based on the RF channel reconfiguration command, a wireless communication using the antenna element set. In some aspects, the means for the RU to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a network node 110 (e.g., a DU) includes means for obtaining, from an RU, capability information associated with at least one antenna element set, the at least one antenna element set comprising a set of antenna elements, of a plurality of antenna elements of the RU, configured for communication while the set of antenna elements is active; and/or means for providing, to the RU, a slot level control plane configuration message comprising an RF channel reconfiguration command that indicates an antenna element set of the at least one antenna element set. In some aspects, the means for the DU to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

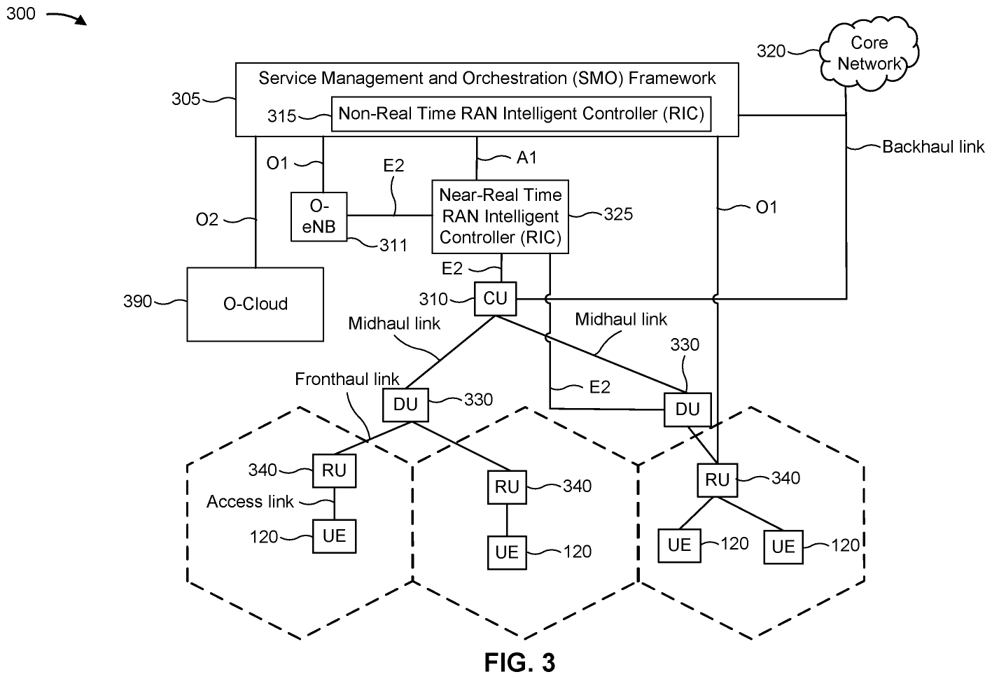

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A DU may transmit control plane (C-plane) messages to an RU via a fronthaul interface. In some examples, C-plane messages may be encapsulated using a two-layer header approach. A first layer may include an enhanced common public radio interface (eCPRI) header, which may include fields to indicate the message type. A second layer may be an application layer that includes fields for control and synchronization. Within the application layer, a “section” defines characteristics of U-plane data to be transmitted or received by the RU using a beam with an associated pattern identifier.

Various section types are defined for the sections in the application layer, and a structure of the C-plane message may be different for different section types. In some cases, section types (e.g., section type 0, section type 1, section type 3, and/or section type 4, among other examples) in the O-RAN fronthaul interface standard are designed to provide information on a per extended antenna-carrier (eAxC) (e.g., per spatial layer) and a per resource block (RB) (or group of RBs) basis. Such section types may be well-suited for some information, such as digital beamforming information, that can change on a per RB or per spatial layer basis. However, some information, such as analog beamforming information, time domain duplex (TDD) configuration, and/or idle or guard periods, may apply to a group of carriers or band sectors. For example, such information may apply to all RBs and spatial layers in a group of carriers or band sectors. Repeating transmission of such information on a per RB and per spatial layer basis may utilize a large amount of C-plane signaling overhead, which may increase processing time for the RU and reduce network speed.

In some cases, Network Energy Savings (NES) in an RU can be supported by selectively turning off carriers or selectively turning off RF channels. When turning off carriers, the whole frequency range of the carrier is affected. When turning off RF channels, the whole Tx/Rx-array is affected. The duration of any of these measures can be expected to be fairly long. For example, the duration can be multiple slots or even undetermined (e.g., the carriers and/or RF channels can be turned off until explicitly turned back on).

For long time scales, when carriers may be cleared and deactivated, management plane (“M-plane”) transactions can be used. However, for shorter time scales, M-plane transactions may not be appropriate, as M-plane transactions may not facilitate precise timing useful for activation and deactivation of carriers and/or RF channels. Accordingly, C-plane messages can be used.

Although the section type 0 C-plane message was explicitly created to support energy savings (and antenna calibration) by indicating to the RU frequency ranges that would be unoccupied, the section type 0 C-plane message applies to specific frequency ranges, not the whole carrier. This can be mitigated by using numPrbc=0, but that is not required. Additionally, section type 0 C-plane messaging applies to just the designated endpoints. This can be mitigated using a section extension 7 (or 10) to indicate application to multiple endpoints, but there is some risk the DU may miss some endpoints. Even with the mitigations, the processing needed for section type 0, more deeply parsing the message and ensuring the correct endpoints are selected, can be unnecessarily extensive.

Some aspects of the techniques and apparatuses described herein may utilize an idle channel (referred to as “IDLE-CHANNEL”) command to indicate antenna elements to be activated and/or deactivated by an RU. The command may be provided using a section type 4 control plane message since section type 4 messaging applies to all endpoints within the stated command scope. The RU may report as a capability at least one antenna element set that corresponds to permitted antenna mask permutations (e.g., at least one set of antenna elements that, when active, are configured to communicate). The at least one antenna set may be referred to as a “selectable antenna set.” In some aspects, a flag may indicate that each antenna set of a plurality of antenna sets (and/or that any antenna set) is a selectable antenna set. The DU may provide a slot level control plane configuration message including an RF channel reconfiguration command that indicates the at least one antenna element set. In some aspects, the indication of the at least one antenna element set may be referred to as an antenna mask. In this way, the impacted endpoints may use just the mask-bit=1 antenna elements, allowing the mask-bit=0 antenna elements to be turned off for the duration of the command. In some aspects, to simplify beamforming weight management, beamforming weights associated with the mask-bit=0 antenna elements may be ignored. In this way, some aspects may facilitate activating and deactivating antenna elements at RUs to achieve network energy savings.

In some aspects, sleep modes may be defined for facilitating activation and/or deactivation of C-plane processing. The sleep modes may include, for example, “light hibernate” and “deep hibernate” sleep modes in which only the M-Plane processing circuits (with or without synchronization) remain active. In some aspects, the RU may report, to the DU, the sleep modes and/or wake-up times associated therewith.

In some aspects, for example, a DU may provide a transmission control (“TRX-CONTROL”) command (e.g., a slot-level transmission C-plane message). In some aspects, the RU may provide sleep mode capability information that indicates a capability of the RU to support sleep modes, supported sleep modes, wake-up times associated with each sleep mode, defined sleep durations (e.g., that are configured via M-plane messaging), and/or permitted antenna mask and antenna layer mask permutations. The DU may enable a TRX-CONTROL capability and use it with Section Type 4 messages. The impacted endpoints may use just the mask-bit=1 array elements, allowing the mask-bit=0 array elements to be turned off (put to sleep) for the duration of the command. If all array elements are to be put to sleep, the mask would be all zeros. If all antenna elements are to be made active, the mask would be all ones. Alternatively, the cmdScope may be used to control all array elements at once. To simplify beamforming weight management, beamforming weights associated with the mask-bit=0 antenna elements may be provided by the DU, but the RU may ignore them.

FIG. 4 is a diagram illustrating an example 400 associated with providing a slot level control plane RF channel reconfiguration command, in accordance with the present disclosure. As shown in FIG. 4, a DU 402 and an RU 404 may communicate with one another. The RU 404 may communicate with a network node 406. The network node 406 may be, be similar to, include, or be included in, the network node 110 depicted in FIGS. 1 and 2, the UE 120 depicted in FIGS. 1-3, and/or one or more components of the disaggregated base station architecture 300 depicted in FIG. 3.

As shown by reference number 408, the RU 404 may provide, and the DU 402 may obtain, capability information. The capability information may be associated with at least one antenna element set. The at least one antenna element set may include a set of antenna elements 410, of a plurality 412 of antenna elements of the RU 404, configured for communication while the set of antenna elements 410 is active. In some aspects, the capability information may explicitly indicate the at least one antenna set. In some aspects, the capability information may include a flag that indicates that each antenna element set of the plurality of antenna elements is a selectable antenna element set.

In some aspects, the capability information may include sleep mode capability information indicating a set of defined sleep duration values supported by the RU 404. In some aspects, the sleep mode capability information may indicate a set of sleep modes supported by the RU 404. The sleep mode capability information further may indicate, for each sleep mode of the set of sleep modes, a respective associated wake-up time of a set of wake-up times. The sleep mode capability information may indicate, for each wake-up time of the set of wake-up times, a value type. The value type may include a definite value type or a minimum value type. In some aspects, the capability information may indicate whether the RU 404 supports a section type 8 ready communication and/or an emergency wake-up command.

As shown by reference number 414, the DU 402 may provide, and the RU 404 may obtain, a slot level control plane configuration message 416. The slot level control plane configuration message 416 may apply to all RBs in a slot, for each endpoint in the group of one or more endpoints. As shown, the slot level control plane configuration message 416 may include a header field that indicates the message 416 as a section type 4 IDLE-CHANNEL command message. The slot level control plane configuration message 416 may include a transport header, a common section type 4 header, a section type 4 common part of command header, and reserved bits that may be used in cases in which the slot level control plane configuration message 416 is used to provide commands other than antenna element activation commands.

The transport header may indicate information about a message, such as a message type, transmission source identifiers, destination identifiers, and/or sequence number identifiers. The transport header may be an eCPRI transport header, such as an eCPRI transport header. In some aspects, the transport header may include an indication of an eAxC identifier. The common section header may indicate a group of one or more endpoints (e.g., RUs and/or antenna panels of an RU) to which the information in the one or more section type commands applies.

The common section header may be information that applies to all of the one or more section type commands associated with the common section header. The common section header may identify a group of carriers or band sectors to which the one or more section type commands apply. The one or more section type commands may include information associated with a slot level common configuration that applies to all resource blocks and spatial layers in the group of carriers or band sectors identified in the common section header. A plurality of command types may be associated with the dedicated section type, with each command type corresponding to a type of information that may be configured in a slot level common configuration. Each of the one or more section type commands included in the slot level control plane configuration message 416 may be associated with a respective command type of the plurality of command types associated with the dedicated section type. The command based structure for the slot level control plane configuration message 416 associated with the dedicated section type may provide an extendable slot level control plane messaging framework, in which different section type commands may be used to indicate different slot level configuration information.

As shown, the slot level control plane configuration message 416 may include an RF channel reconfiguration command 418 (shown as “antMask” since the command 418 may be referred to as an “antenna mask”) that indicates an antenna element set of the at least one antenna element set. In some aspects, for example, the bitmap may include a bit corresponding to each antenna element 410 of the plurality 412 of antenna elements of the RU 404. For example, the bitmap may indicate a value of 0 for an antenna element that is to be deactivated (or remain inactive) and a value of 1 for an antenna element that is to be activated (or remain active). In some aspects, the RF channel reconfiguration command may correspond to a set of time resources. In some aspects, the slot level control plane configuration message may indicate the set of time resources. In some aspects, the slot level control plane configuration message 416 may include a directional indicator 420 (shown as “bothDir”) that indicates whether the antenna mask applies to both directions of communication (e.g., uplink and downlink). For example, a value of 1 may indicate both directions, while a value of 0 may indicate only one direction.

As shown by reference number 422, the DU 402 may transmit, and the RU 404 may receive, a management plane message. In some aspects, obtaining the management plane message may include obtaining the management plane message during a sleep duration associated with the sleep mode. In some aspects, the management plane message may be provided based on the sleep mode capability information. In some aspects, the management plane message may include an indication of a subset of defined sleep duration values, of a set of defined sleep duration values, associated with a control plane processing component of the RU 404. The control plane processing component may be, include, be included in, or be associated with the indicated antenna element set to be activated and/or deactivated. In some aspects, the management plane message may include an indication of an undefined sleep duration associated with a control plane processing component of the RU 404. In some aspects, the management plane message may include an emergency wake-up indication.

As shown by reference number 424, the DU 402 may transmit, and the RU 404 may receive, a wake up command associated with the control plane processing component of the RU 404. As shown by reference number 426, based on receiving the wake-up command, the RU 404 may activate the control plane processing component. For example, the RU 404 may transition the control plane processing component from a sleep mode to an awake mode. As shown by reference number 428, the RU 404 may activate, based on the RF channel reconfiguration command, each antenna element 410 of the antenna element set. In some cases, activating an antenna element may refer to allowing an already active antenna element to remain active. As shown by reference number 430, the RU 404 may deactivate, based on the RF channel reconfiguration command, each antenna element 410 of the plurality 412 of antenna elements that is omitted from the antenna element set. In some cases, deactivating an antenna element may refer to allowing an already inactive antenna element to remain inactive.

As shown by reference number 432, the UR 404 may transmit, and the DU 402 may receive, a ready communication. The ready communication may indicate that the RU 404 is ready to communicate data traffic. In some aspects, the ready communication may be transmitted based on the sleep mode having the minimum value type. The ready communication may indicate that the RU 404 is ready to communicate data traffic.

As shown by reference number 434, the RU 404 may communicate. For example, the RU 404 may communicate with the network node 406 based on the RF channel reconfiguration command. Communicating may refer to transmitting or receiving a wireless communication using the antenna element set. In some aspects, the DU 402 may provide (in another control plane message) an indication of a group of beamforming weight values, each beamforming weight value of the plurality of beamforming weight values corresponding to a respective antenna element 410 of the plurality 412 of antenna elements 410. The RU 404 may communicate the wireless communication based on a set of beamforming weights, of the group of beamforming weight values, corresponding to the set of antenna elements (e.g., by ignoring beamforming weights corresponding to deactivated antenna elements). In some other aspects, the DU 402 may refrain from computing and providing, to the RU 404, indications of beamforming weight values corresponding to antenna elements that are indicated by the RF channel reconfiguration command 418 (e.g., the bitmap described above) as being deactivated. In this way, some other aspects may facilitate reducing fronthaul interface bandwidth consumption and computing resource consumption.

In some aspects, the DU 402 may transmit, and the RU 404 may receive, an additional slot level control plane configuration message that includes a reactivate command associated with the antenna element set. The RU 404 may reactivate, at a reactivation time and based on the reactivate command, the antenna element set. In some aspects, the reactivation time may correspond to a wake-up time, of the set of wake-up times, associated with the sleep mode based on the sleep mode having the definite value type.

FIG. 4B is a diagram illustrating an example 436 of a transmission control message, in accordance with the present disclosure. The transmission control message may be transmitted by the DU 402 to the RU 404. As shown, the transmission control message may be a Section Type 4 command including a per slot idle/active meant for power saving/transmission blanking use cases. Common cases may include idle for one direction (bothDir=0, dataDirection bit indicates UL/DL) or both directions (bothDir=1, ignore dataDirection bit), for multiple slots or (numSlots=0) continuously until a same-scope command is received. The slot duration may determined by the “scs” parameter in the common Section Type 4 header.

The appropriate command scope (cmdScope) for this command may be ARRAY-COMMAND, CARRIER-COMMAND, or O-RU-COMMAND. In some aspects, when cmdScope is CARRIER-COMMAND or O-RU-COMMAND, the turnOn bit may indicate whether all array elements are turned on or off, otherwise onOff may be “reserved.” A default value may be set such that (before any command is issued) all array elements are on. In some aspects, the command scope value may include turnOn=0: turn off or turnOn=1: turn on. When cmdScope=ARRAY-COMMAND, then the antLayerMask and antMask fields are present, and if not, antLayerMask may be changed to “reserved” and antMask may be omitted.

The antMask field may include bits that refer to the numbered antenna elements, where element #0 corresponds to the least significant bit of the mask. If the mask is larger than the number of antenna elements, the most significant bits may be set to zero (e.g., not disabled). The antLayerMask field may include bits that refer to the antenna layers (numbered by Q). A present Q #0 may correspond to the least significant bit of the mask.

The sleepDurIndex field may indicate the M-plane-configured sleep duration if numSlots=0, otherwise it may be ignored (e.g., the value 0×0 may be reserved and the Value 0×F may indicate an undefined duration). In some aspects, when turnOn=1 (“on”), numSlots and sleepDurIndex may be ignored, as “on” may include an undefined duration by definition. The log2maskbits may specify the length of the antenna mask in powers of 2. For example, a log2maskbits field value of 1 may indicate 2 mask bits, a value of 4 may indicate 16 mask bits, a value of 6 may indicate 64 mask bits, and so on. The maximum possible number of mask bits may be 2¹⁴ or 16384 mask bits (e.g., 0 and 0×F may be reserved). When the value is less than 5 (less than 32 elements), the 4-byte word (msbs) may be padded with zeros.

The sleepMode field may indicate a sleep mode associated with a C-plane processing component of the RU 404. In some aspects, for example, a sleepMode field value of 0 may indicate a “mode 0”, in which there is no indicated sleep depth. In some aspects, if the sleepMode indicates the mode 0, the DU 402 may issue another TRX-COMMAND in any future slot. A sleepMode field value of 1 may indicate a “mode 1” sleep mode. In some aspects, if the sleepMode field indicates mode 1, the DU 402 may activate antenna elements and/or layers only after L slots after a slot number associated with the transmission control message indicating the sleep mode. In some aspects, a sleepMode field value of 2 may indicate a “mode 2” sleep mode. In some aspects, if the sleepMode field value indicates mode 2, the DU 402 may activate antenna elements and/or layers only after M slots after a slot number associated with the transmission control message indicating the sleep mode. In some aspects, a sleepMode field value of 3 may indicate a “mode 3” sleep. In some aspects, if the sleepMode field indicates mode 3, the DU 402 may activate antenna elements and/or layers only after N slots after a slot number associated with the transmission control message indicating the sleep mode. In some aspects, the L, M, and N wake-up times may be of a “guaranteed” type or “minimum” type, as indicted by the RU 404.

In some aspects, TRX-CONTROL commands may be configured to adhere to a set of rules. For example, in some aspects, only one TRX-CONTROL command may be sent to an RU 404 per slot per transmission or reception array. In some aspects, a new sleep command (e.g., indicating additional transmission antenna elements and/or layers to be masked) may be configured to have the same sleepMode as the previous sleep command. In some aspects, once a wake-up command is issued (e.g., resulting in fewer transmission antenna elements and/or layers masked) no new TRX-CONTROL command may be issued during the wake-up interval. In some aspects, where turnOn is relevant and is equal to 1, the duration may be undefined by definition, and the RU 404 may ignore the numSlots field and the sleepDurIndex field.

In some aspects, a TRX-control command (as represented by the control plane message) may be used in the context of defined sleep durations. In some aspects, the DU 402 may read the RU 404 sleep capabilities, including L, M, and N values for the supported sleep levels. When the DU 402 wishes to deactivate and/or reactivate some or all antenna elements and/or layers, the DU 402 may issue the TRX-CONTROL command. If, in the TRX-CONTROL command, numslots≠0, the sleep duration is known as a specified number of slots, and sleepMode may be set to the maximum possible value such that numSlots≥L or M or N. If numSlots<L, then sleepMode may be set to 0 and the RU 404 may ignore the SleepDurIndex field. In some aspects, if numSlots=0 and sleepDurIndex≠0×F, then the sleep duration is known via M-plane messaging and may include any number of values up to a configured maximum number of values (e.g., up to 14 possible values). In this case, C-plane processing may be turned off for the designated duration. The sleepMode field may regulate the wake-up time and whether a ready command will be generated (if the wake-up time is not guaranteed) to indicate the RU 404 is ready to operate. In some aspects, as shown in FIG. 8C, instead of a sleepDurIndex, the TRX-CONTROL command may include one or more numSlotsExt fields to indicate a number of slots to be added to the number of slots indicated by the numSlots field to extend a defined-duration sleep interval.

In some aspects, a TRX-control command (as represented by the control plane message) may be used in the context of undefined sleep durations. For example, the DU 402 may read the RU 404 sleep capabilities, including L, M, and N values for the supported sleep levels. When the DU 402 wishes to deactivate and/or reactivate some or all antenna elements and/or layers, the DU 402 may issue the TRX-CONTROL command. If numSlots=0, sleepDurIndex=0×F, and sleepMode=0, there is no specified sleep duration, and antenna elements may be activated in any future slot with no minimum sleep duration If numslots=0, sleepDurIndex=0×F, and sleepMode≠0, the RU 404 may enter the commanded sleep mode and the DU 402 may not activate antenna elements and/or layers (as specified by the new masks) earlier than L, M, or N slots later. When a new TRX-CONTROL command is received by the RU 404, the RU 404 may activate the new mask exactly L, M, or N slots after receiving the command if those wake-up times are guaranteed. Otherwise, the RU 404 may activate the new mask in the slot following the issuance of a “ready” command by the RU 404. This rule may hold true even if the new mask uses fewer antenna elements than the previous mask.

FIG. 4C is a diagram illustrating another example 438 of a transmission control message, in accordance with the present disclosure. The transmission control message may be transmitted by the DU 402 to the RU 404. As shown, the transmission control message may be a Section Type 4 command including a per slot idle/active meant for power saving/transmission blanking use cases. In some aspects, the transmission control message may be similar to the transmission control message of example 436 depicted in FIG. 4B with the exception of additional fields included to facilitate muting spatial streams. A spatial stream may be a data layer associated with a particular beam. For example, in some cases, when a number of active antennas is changed, a number of spatial streams transmitted using the active antennas may be changed. In some aspects, by indicating one or more spatial streams to be muted, the transmission control message may facilitate energy savings (e.g., by causing RU to transmit a limited number of spatial streams associated with a limited number of beams).

As shown, the transmission control message may include a spatial stream mute index field (shown as “ssMuteIndex”) that may be populated with a spatial stream mute index value to indicate whether spatial streams are to be muted. For example, in some aspects, a first value (e.g., ssMuteIndex=0) of the spatial stream mute index may indicate that no spatial streams are to be muted (e.g., all configured spatial streams are available to the DU). A second value (e.g., ssMuteIndex≠0) may indicate that one or more spatial streams are to be muted. In some aspects, the ssMuteIndex may take up to 15 values.

For example, the spatial stream mute index value may indicate a quantity of supported spatial streams. In some aspects, for example, an M-Plane configuration message may configure a set of spatial streams and the spatial stream mute index value may indicate a quantity of the total quantity of spatial streams in the set of spatial streams to be muted. For example, ssMuteIndex=1 may indicate that two spatial streams are to be muted, ssMuteIndex=2 may indicate that four spatial streams are to be muted, and/or ssMuteIndex=3 may indicate that seven spatial streams are to be muted, among other examples. Alternatively, the spatial stream mute index value may indicate a quantity of spatial streams, of the configured spatial streams, to remain active.

In some aspects, the spatial stream mute index value may indicate the spatial streams that are to be muted. For example, an M-Plane configuration message may configure a set of explicit spatial stream identifiers (IDs) and the ssMuteIndex value may indicate the spatial stream ID or IDs of the spatial stream or spatial streams to be muted. Alternatively, the spatial stream mute index value may indicate the spatial stream ID or IDs of the spatial stream or spatial streams to remain active.

FIG. 4D is a diagram illustrating an example 440 of a transmission control message used as a ready communication (a “ready command”), in accordance with the present disclosure. The transmission control message may be transmitted by the DU 402 to the RU 404. In some aspects, for example, the transmission control message may be a section type 8 command.

In some aspects, a TRX-CONTROL ready communication (e.g., a TRX-CONTROL command, as represented by the control plane message) may be used in the context of defined sleep durations. In some aspects, the DU 402 may read the RU 404 sleep capabilities, including L, M, and N values for the supported sleep levels and may provide a command to deactivate some or all antenna elements. When the DU 402 wishes to reactivate some antenna elements and/or layers, or the entire RU 404, the DU 402 may provide the wake-up TRX-CONTROL command L, M, or N slots prior to sending any C or U plane traffic.

In some aspects, the RU 404 may provide an indication as to whether each of the wake-up times L, M, and N are guaranteed or minimum. A guaranteed wake-up time is a wake-up time associated with a wake-up interval after which the RU 404 will be ready to operate after the wake-up interval. A minimum wake-up time is a wake-up time that accommodates changes in the external environment. In some aspects, if the RU 404 indicates that the wake-up times are minimum times, the RU 404 may provide a ready command to the DU 402 to inform the DU 402 that the DU 402 is ready to operate starting with the next slot. For example, in some aspects, the RU 404 may need to recalibrate during the wake-up interval. The RU 404 may issue calibration requests during the wake-up interval that the DU 402 is expected to respond to, or the RU 404 may do a self-calibration during the wake-up interval. All of this may unexpectedly lengthen the wake-up interval beyond the expected, but not guaranteed, number of slots. In some other cases, the wake-up interval may be shorter than the expected, but not guaranteed, number of slots.

In some aspects, a TRX-CONTROL ready communication (e.g., a TRX-CONTROL command, as represented by the control plane message) may be used in the context of undefined sleep durations. The DU 402 may issue an undefined sleep duration command, after which it may issue another command to wake up some or all antenna elements. When the indicated sleep mode is associated with minimum wake-up times, the RU 404 may issue the ready command to indicate when the wake-up time is completed. The DU 402 may start C and U plane processing on the next slot. In some aspects, the ready command may be issued in symbol zero of the slot prior to the slot where C and U plane traffic can be processed, and the ready command may only be used for sleep modes with minimum wake-up times.

The reserved least significant bit in octet 13 may be used to indicate a ready command. As a reserved bit, its usual value is zero and, when it is one then this message is an Advanced Sleep Mode ready command, indicating that the wake-up process is complete. In some aspects, when ASMready=1, then numberOfAcks may be 0 and numberOfNacks may be 0, and no ackIds and nackIds may be included in the message.

A section type 8 command may be transmitted by the RU 404 in symbol 0 of the slot prior to the slot in which the DU 402 may issue C and U plane commands to the O-RU. The RU 404 may transmit the section type 8 command in the case of a transition from no antenna elements activated to some or all antenna elements activated, and/or in the case of some antenna elements being already activated and more antenna elements being activated.

As indicated above, FIGS. 4A-4D are provided as examples. Other examples may differ from what is described with respect to FIGS. 4A-4D.

FIG. 5 is a diagram illustrating an example process 500 performed, for example, by a RU, in accordance with the present disclosure. Example process 500 is an example where the RU (e.g., RU 404) performs operations associated with techniques for providing a slot level control plane RF channel reconfiguration command.

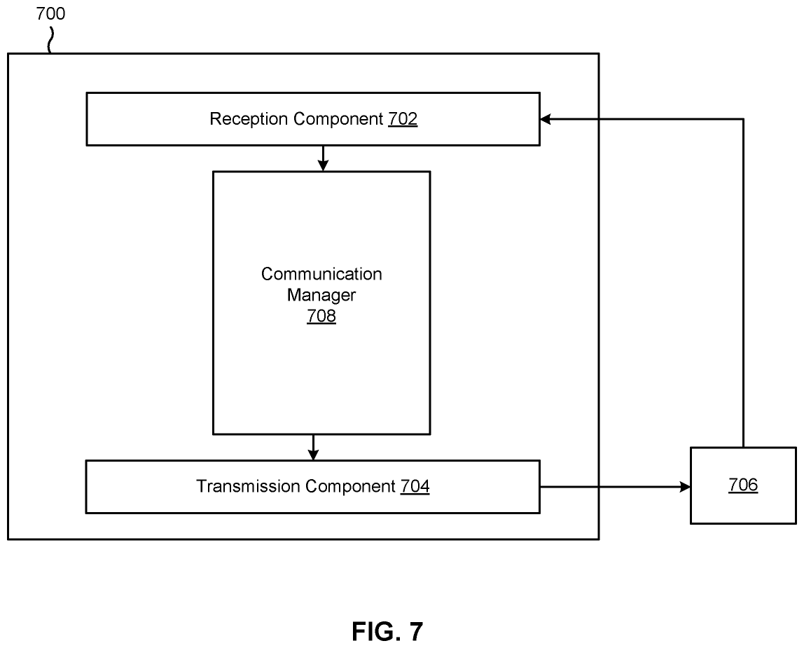

As shown in FIG. 5, in some aspects, process 500 may include providing, to a DU, capability information associated with at least one antenna element set, the at least one antenna element set comprising a set of antenna elements, of a plurality of antenna elements of the RU, configured for communication while the set of antenna elements is active (block 510). For example, the RU (e.g., using communication manager 708 and/or transmission component 704, depicted in FIG. 7) may provide, to a DU, capability information associated with at least one antenna element set, the at least one antenna element set comprising a set of antenna elements, of a plurality of antenna elements of the RU, configured for communication while the set of antenna elements is active, as described above.

As further shown in FIG. 5, in some aspects, process 500 may include obtaining, from the DU, a slot level control plane configuration message comprising an RF channel reconfiguration command that indicates an antenna element set of the at least one antenna element set (block 520). For example, the RU (e.g., using communication manager 708 and/or reception component 702, depicted in FIG. 7) may obtain, from the DU, a slot level control plane configuration message comprising an RF channel reconfiguration command that indicates an antenna element set of the at least one antenna element set, as described above.

As further shown in FIG. 5, in some aspects, process 500 may include communicating, based on the RF channel reconfiguration command, a wireless communication using the antenna element set (block 530). For example, the RU (e.g., using communication manager 708, reception component 702, and/or transmission component 704, depicted in FIG. 7) may communicate, based on the RF channel reconfiguration command, a wireless communication using the antenna element set, as described above.

Process 500 may include additional aspects, such as any single aspect or any combination of aspects described below and/or in connection with one or more other processes described elsewhere herein.

In a first aspect, process 500 includes providing, to the DU, a ready communication that indicates that the RU is ready to communicate data traffic, wherein communicating the wireless communication comprises communicating the wireless communication based on providing the ready communication.

In a second aspect, alone or in combination with the first aspect, process 500 includes providing, to the DU, sleep mode capability information indicating a set of defined sleep duration values supported by the RU, and obtaining, from the DU and based on the sleep mode capability information, a management plane message including an indication of a subset of defined sleep duration values, of the set of defined sleep duration values, associated with a control plane processing component of the RU.

In a third aspect, alone or in combination with one or more of the first and second aspects, the slot level control plane configuration message includes an indication of a deactivation of the antenna element set, the method further comprising providing to the DU, sleep mode capability information indicating a set of sleep modes supported by the RU, wherein the sleep mode capability information further indicates, for each sleep mode of the set of sleep modes, a respective associated wake-up time of a set of wake-up times, and wherein the indication of the deactivation of the antenna element set is associated with a sleep mode of the set of sleep modes, obtaining, from the DU, an additional slot level control plane configuration message comprising a reactivate command associated with the antenna element set, and reactivating, at a reactivation time and based on the reactivate command, the antenna element set.

In a fourth aspect, alone or in combination with the third aspect, the sleep mode capability information indicates, for each wake-up time of the set of wake-up times, a value type, the value type comprising a definite value type or a minimum value type.

In a fifth aspect, alone or in combination with the fourth aspect, the reactivation time corresponds to a wake-up time, of the set of wake-up times, associated with the sleep mode based on the sleep mode having the definite value type.

In a sixth aspect, alone or in combination with the fourth aspect, process 500 includes providing, to the DU and based on the sleep mode having the minimum value type, a ready communication that indicates that the RU is ready to communicate data traffic, wherein the reactivation time is based on a time associated with providing the ready communication.

In a seventh aspect, alone or in combination with one or more of the first through sixth aspects, process 500 includes obtaining, from the DU, a management plane message including an indication of an undefined sleep duration associated with a control plane processing component of the RU, obtaining, from the DU, a wake up command associated with the control plane processing component of the RU, and activating the control plane processing component based on the wake up command.

In an eighth aspect, alone or in combination with one or more of the first through seventh aspects, process 500 includes obtaining, from the DU, a management plane message including an emergency wake-up indication, and transitioning a control plane processing component from a sleep mode to an awake mode based on the emergency wake-up indication.

In a ninth aspect, alone or in combination with the eighth aspect, obtaining the management plane message comprises obtaining the management plane message during a sleep duration associated with the sleep mode.

In a tenth aspect, alone or in combination with one or more of the first through ninth aspects, process 500 includes activating, based on the RF channel reconfiguration command, each antenna element of the antenna element set, and deactivating, based on the RF channel reconfiguration command, each antenna element of the plurality of antenna elements that is omitted from the antenna element set.

In an eleventh aspect, alone or in combination with one or more of the first through tenth aspects, the capability information explicitly indicates the at least one antenna set.

In a twelfth aspect, alone or in combination with one or more of the first through eleventh aspects, the capability information comprises a flag that indicates that each antenna element set of the plurality of antenna elements is a selectable antenna element set.

In a thirteenth aspect, alone or in combination with one or more of the first through twelfth aspects, the RF channel reconfiguration command comprises a bitmap, each bit of the bitmap corresponding to a respective antenna element of the plurality of antenna elements.

In a fourteenth aspect, alone or in combination with one or more of the first through thirteenth aspects, the RF channel reconfiguration command corresponds to a set of time resources.

In a fifteenth aspect, alone or in combination with the fourteenth aspect, the slot level control plane configuration message indicates the set of time resources.

In a sixteenth aspect, alone or in combination with one or more of the first through fifteenth aspects, process 500 includes receiving an indication of a group of beamforming weight values, each beamforming weight value of the plurality of beamforming weight values corresponding to a respective antenna element of the plurality of antenna elements, and communicating the wireless communication comprises communicating the wireless communication based on a set of beamforming weights, of the group of beamforming weight values, corresponding to the set of antenna elements.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a DU, in accordance with the present disclosure. Example process 600 is an example where the DU (e.g., DU 402) performs operations associated with techniques for providing a slot level control plane RF channel reconfiguration command.

As shown in FIG. 6, in some aspects, process 600 may include obtaining, from an RU, capability information associated with at least one antenna element set, the at least one antenna element set comprising a set of antenna elements, of a plurality of antenna elements of the RU, configured for communication while the set of antenna elements is active (block 610). For example, the DU (e.g., using communication manager 708 and/or reception component 702, depicted in FIG. 7) may obtain, from an RU, capability information associated with at least one antenna element set, the at least one antenna element set comprising a set of antenna elements, of a plurality of antenna elements of the RU, configured for communication while the set of antenna elements is active, as described above.

As further shown in FIG. 6, in some aspects, process 600 may include providing, to the RU, a slot level control plane configuration message comprising an RF channel reconfiguration command that indicates an antenna element set of the at least one antenna element set (block 620). For example, the DU (e.g., using communication manager 708 and/or transmission component 704, depicted in FIG. 7) may provide, to the RU, a slot level control plane configuration message comprising an RF channel reconfiguration command that indicates an antenna element set of the at least one antenna element set, as described above.

Process 600 may include additional aspects, such as any single aspect or any combination of aspects described below and/or in connection with one or more other processes described elsewhere herein.

In a first aspect, process 600 includes obtaining, from the RU, a ready communication that indicates that the RU is ready to communicate data traffic, and communicating with the RU based on providing the ready communication.

In a second aspect, alone or in combination with the first aspect, process 600 includes providing, to the RU, a management plane message including an indication of quantity of wake-up durations associated with a control plane processing component of the RU.

In a third aspect, alone or in combination with one or more of the first and second aspects, process 600 includes obtaining, from the RU, sleep mode capability information indicating a set of defined sleep duration values supported by the RU, and providing, to the RU and based on the sleep mode capability information, a management plane message including an indication of a subset of defined sleep duration values, of the set of defined sleep duration values, associated with a control plane processing component of the RU.

In a fourth aspect, alone or in combination with one or more of the first through third aspects, the slot level control plane configuration message includes an indication of a deactivation of the antenna element set, the method further comprising obtaining from the RU, sleep mode capability information indicating a set of sleep modes supported by the RU, wherein the sleep mode capability information further indicates, for each sleep mode of the set of sleep modes, a respective associated wake-up time of a set of wake-up times, and wherein the indication of the deactivation of the antenna element set is associated with a sleep mode of the set of sleep modes, providing, to the RU, an additional slot level control plane configuration message comprising a reactivate command associated with the antenna element set, and reactivating, at a reactivation time and based on the reactivate command, the antenna element set.

In a fifth aspect, alone or in combination with the fourth aspect, the sleep mode capability information indicates, for each wake-up time of the set of wake-up times, a value type, the value type comprising a definite value type or a minimum value type.

In a sixth aspect, alone or in combination with the fifth aspect, the reactivation time corresponds to a wake-up time, of the set of wake-up times, associated with the sleep mode based on the sleep mode having the definite value type.

In a seventh aspect, alone or in combination with the fifth aspect, process 600 includes obtaining, from the RU and based on the sleep mode having the minimum value type, a ready communication that indicates that the RU is ready to communicate data traffic, wherein the reactivation time is based on a time associated with providing the ready communication.

In an eighth aspect, alone or in combination with one or more of the first through seventh aspects, process 600 includes providing, to the RU, a management plane message including an indication of an undefined sleep duration associated with a control plane processing component of the RU, providing, to the RU, a wake up command associated with the control plane processing component of the RU, and activating the control plane processing component based on the wake up command.

In a ninth aspect, alone or in combination with one or more of the first through eighth aspects, process 600 includes providing, to the RU, a management plane message including an emergency wake-up indication associated with a transition, of a control plane processing component of the RU, from a sleep mode of the RU to an awake mode of the RU.

In a tenth aspect, alone or in combination with the ninth aspect, providing the management plane message comprises providing the management plane message during a sleep duration associated with the sleep mode of the RU.

In an eleventh aspect, alone or in combination with one or more of the first through tenth aspects, the capability information explicitly indicates the at least one antenna set.

In a twelfth aspect, alone or in combination with one or more of the first through eleventh aspects, the capability information comprises a flag that indicates that each antenna element set of the plurality of antenna elements is a selectable antenna element set.

In a thirteenth aspect, alone or in combination with one or more of the first through twelfth aspects, the RF channel reconfiguration command comprises a bitmap, each bit of the bitmap corresponding to a respective antenna element of the plurality of antenna elements.

In a fourteenth aspect, alone or in combination with one or more of the first through thirteenth aspects, the RF channel reconfiguration command corresponds to a set of time resources.

In a fifteenth aspect, alone or in combination with the fourteenth aspect, the slot level control plane configuration message indicates the set of time resources.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a network node (e.g., an RU and/or a DU), or a network node may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include a communication manager 708.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5, process 600 of FIG. 6, or a combination thereof. In some aspects, the apparatus 700 and/or one or more components shown in FIG. 7 may include one or more components of the network node described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the network node described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the network node described in connection with FIG. 2. In some aspects, the transmission component 704 may be co-located with the reception component 702 in a transceiver.

In some examples, means for transmitting, outputting, or sending (or means for outputting for transmission) may include one or more antennas, a modulator, a transmit MIMO processor, a transmit processor, or a combination thereof, of the network node described above in connection with FIG. 2.

In some examples, means for receiving (or means for obtaining) may include one or more antennas, a demodulator, a MIMO detector, a receive processor, or a combination thereof, of the network node described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for obtaining, providing, transmitting, receiving, activating, deactivating, and/or communicating may include various processing system components, such as a receive processor, a transmit processor, a controller/processor, a memory, or a combination thereof, of the network node described above in connection with FIG. 2.

The communication manager 708 and/or the transmission component 704 may provide, to a DU, capability information associated with at least one antenna element set, the at least one antenna element set comprising a set of antenna elements, of a plurality of antenna elements of the RU, configured for communication while the set of antenna elements is active. In some aspects, the communication manager 708 may include one or more antennas, a modem, a controller/processor, a memory, or a combination thereof, of the network node described in connection with FIG. 2. In some aspects, the communication manager 708 may include the reception component 702 and/or the transmission component 704. In some aspects, the communication manager 708 may be, be similar to, include, or be included in, the communication manager 150 depicted in FIGS. 1 and 2. The communication manager 708 and/or the reception component 702 may obtain, from the DU, a slot level control plane configuration message comprising an RF channel reconfiguration command that indicates an antenna element set of the at least one antenna element set. The communication manager 708, the reception component 702, and/or the transmission component 704 may communicate, based on the RF channel reconfiguration command, a wireless communication using the antenna element set.

The communication manager 708, the reception component 702, and/or the transmission component 704 may activate, based on the RF channel reconfiguration command, each antenna element of the antenna element set. The communication manager 708, the reception component 702, and/or the transmission component 704 may deactivate, based on the RF channel reconfiguration command, each antenna element of the plurality of antenna elements that is omitted from the antenna element set. The communication manager 708 and/or the reception component 702 may receive an indication of a group of beamforming weight values, each beamforming weight value of the plurality of beamforming weight values corresponding to a respective antenna element of the plurality of antenna elements, and communicating the wireless communication comprises communicating the wireless communication based on a set of beamforming weights, of the group of beamforming weight values, corresponding to the set of antenna elements.

The communication manager 708 and/or the reception component 702 may obtain, from an RU, capability information associated with at least one antenna element set, the at least one antenna element set comprising a set of antenna elements, of a plurality of antenna elements of the RU, configured for communication while the set of antenna elements is active. The communication manager 708 and/or the transmission component 704 may provide, to the RU, a slot level control plane configuration message comprising an RF channel reconfiguration command that indicates an antenna element set of the at least one antenna element set.

The communication manager 708 and/or the transmission component 704 may provide, to the DU, sleep mode capability information indicating a set of defined sleep duration values supported by the RU. The communication manager 708 and/or the reception component 702 may obtain, from the DU and based on the sleep mode capability information, a management plane message including an indication of a subset of defined sleep duration values, of the set of defined sleep duration values, associated with a control plane processing component of the RU.

The communication manager 708 and/or the reception component 702 may obtain, from the DU, an additional slot level control plane configuration message comprising a reactivate command associated with the antenna element set. The communication manager 708, the reception component 702, and/or the transmission component 704 may reactivate, at a reactivation time and based on the reactivate command, the antenna element set. The communication manager 708 and/or the transmission component 704 may provide, to the DU and based on the sleep mode having the minimum value type, a ready communication that indicates that the RU is ready to communicate data traffic, wherein the reactivation time is based on a time associated with providing the ready communication.

The communication manager 708 and/or the reception component 702 may obtain from the DU, a management plane message including an emergency wake-up indication. The communication manager 708, the reception component 702, and/or the transmission component 704 may transition a control plane processing component from a sleep mode to an awake mode based on the emergency wake-up indication.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a radio unit (RU) for wireless communication, comprising: providing, to a distributed unit (DU), capability information associated with at least one antenna element set, the at least one antenna element set comprising a set of antenna elements, of a plurality of antenna elements of the RU, configured for communication while the set of antenna elements is active; obtaining, from the DU, a slot level control plane configuration message comprising a radio frequency (RF) channel reconfiguration command that indicates an antenna element set of the at least one antenna element set; and communicating, based on the RF channel reconfiguration command, a wireless communication using the antenna element set.

Aspect 2: The method of Aspect 1, further comprising providing, to the DU, a ready communication that indicates that the RU is ready to communicate data traffic, wherein communicating the wireless communication comprises communicating the wireless communication based on providing the ready communication.

Aspect 3: The method of either of claim 1 or 2, further comprising: providing, to the DU, sleep mode capability information indicating a set of defined sleep duration values supported by the RU; and obtaining, from the DU and based on the sleep mode capability information, a management plane message including an indication of a subset of defined sleep duration values, of the set of defined sleep duration values, associated with a control plane processing component of the RU.

Aspect 4: The method of any of Aspects 1-3, wherein the slot level control plane configuration message includes an indication of a deactivation of the antenna element set, the method further comprising: providing to the DU, sleep mode capability information indicating a set of sleep modes supported by the RU, wherein the sleep mode capability information further indicates, for each sleep mode of the set of sleep modes, a respective associated wake-up time of a set of wake-up times, and wherein the indication of the deactivation of the antenna element set is associated with a sleep mode of the set of sleep modes; obtaining, from the DU, an additional slot level control plane configuration message comprising a reactivate command associated with the antenna element set; and reactivating, at a reactivation time and based on the reactivate command, the antenna element set.

Aspect 5: The method of Aspect 4, wherein the sleep mode capability information indicates, for each wake-up time of the set of wake-up times, a value type, the value type comprising a definite value type or a minimum value type.

Aspect 6: The method of Aspect 5, wherein the reactivation time corresponds to a wake-up time, of the set of wake-up times, associated with the sleep mode based on the sleep mode having the definite value type.

Aspect 7: The method of Aspect 5, further comprising providing, to the DU and based on the sleep mode having the minimum value type, a ready communication that indicates that the RU is ready to communicate data traffic, wherein the reactivation time is based on a time associated with providing the ready communication.

Aspect 8: The method of any of Aspects 1-7, further comprising: obtaining, from the DU, a management plane message including an indication of an undefined sleep duration associated with a control plane processing component of the RU; obtaining, from the DU, a wake up command associated with the control plane processing component of the RU; and activating the control plane processing component based on the wake up command.

Aspect 9: The method of any of Aspects 1-8, further comprising: obtaining, from the DU, a management plane message including an emergency wake-up indication; and transitioning a control plane processing component from a sleep mode to an awake mode based on the emergency wake-up indication.

Aspect 10: The method of Aspect 9, wherein obtaining the management plane message comprises obtaining the management plane message during a sleep duration associated with the sleep mode.

Aspect 11: The method of any of Aspects 1-10, further comprising: activating, based on the RF channel reconfiguration command, each antenna element of the antenna element set; and deactivating, based on the RF channel reconfiguration command, each antenna element of the plurality of antenna elements that is omitted from the antenna element set.

Aspect 12: The method of any of Aspects 1-11, wherein the capability information explicitly indicates the at least one antenna set.

Aspect 13: The method of any of Aspects 1-12, wherein the capability information comprises a flag that indicates that each antenna element set of the plurality of antenna elements is a selectable antenna element set.

Aspect 14: The method of any of Aspects 1-13, wherein the RF channel reconfiguration command comprises a bitmap, each bit of the bitmap corresponding to a respective antenna element of the plurality of antenna elements.

Aspect 15: The method of any of Aspects 1-14, wherein the RF channel reconfiguration command corresponds to a set of time resources.

Aspect 16: The method of Aspect 15, wherein the slot level control plane configuration message indicates the set of time resources.

Aspect 17: The method of any of Aspects 1-16, further comprising receiving an indication of a group of beamforming weight values, each beamforming weight value of the plurality of beamforming weight values corresponding to a respective antenna element of the plurality of antenna elements, and wherein communicating the wireless communication comprises communicating the wireless communication based on a set of beamforming weights, of the group of beamforming weight values, corresponding to the set of antenna elements.

Aspect 18: A method of wireless communication performed by a distributed unit (DU) for wireless communication, comprising: obtaining, from a radio unit (RU), capability information associated with at least one antenna element set, the at least one antenna element set comprising a set of antenna elements, of a plurality of antenna elements of the RU, configured for communication while the set of antenna elements is active; and providing, to the RU, a slot level control plane configuration message comprising a radio frequency (RF) channel reconfiguration command that indicates an antenna element set of the at least one antenna element set.

Aspect 19: The method of Aspect 18, further comprising: obtaining, from the RU, a ready communication that indicates that the RU is ready to communicate data traffic; and communicating with the RU based on providing the ready communication.

Aspect 20: The method of either of claim 18 or 19, further comprising providing, to the RU, a management plane message including an indication of quantity of wake-up durations associated with a control plane processing component of the RU.

Aspect 21: The method of any of Aspects 18-20, further comprising: obtaining, from the RU, sleep mode capability information indicating a set of defined sleep duration values supported by the RU; and providing, to the RU and based on the sleep mode capability information, a management plane message including an indication of a subset of defined sleep duration values, of the set of defined sleep duration values, associated with a control plane processing component of the RU.

Aspect 22: The method of any of Aspects 18-21, wherein the slot level control plane configuration message includes an indication of a deactivation of the antenna element set, the method further comprising: obtaining from the RU, sleep mode capability information indicating a set of sleep modes supported by the RU, wherein the sleep mode capability information further indicates, for each sleep mode of the set of sleep modes, a respective associated wake-up time of a set of wake-up times, and wherein the indication of the deactivation of the antenna element set is associated with a sleep mode of the set of sleep modes; providing, to the RU, an additional slot level control plane configuration message comprising a reactivate command associated with the antenna element set; and reactivating, at a reactivation time and based on the reactivate command, the antenna element set.

Aspect 23: The method of Aspect 22, wherein the sleep mode capability information indicates, for each wake-up time of the set of wake-up times, a value type, the value type comprising a definite value type or a minimum value type.

Aspect 24: The method of Aspect 23, wherein the reactivation time corresponds to a wake-up time, of the set of wake-up times, associated with the sleep mode based on the sleep mode having the definite value type.

Aspect 25: The method of Aspect 23, further comprising obtaining, from the RU and based on the sleep mode having the minimum value type, a ready communication that indicates that the RU is ready to communicate data traffic, wherein the reactivation time is based on a time associated with providing the ready communication.

Aspect 26: The method of any of Aspects 18-25, further comprising: providing, to the RU, a management plane message including an indication of an undefined sleep duration associated with a control plane processing component of the RU; providing, to the RU, a wake up command associated with the control plane processing component of the RU; and activating the control plane processing component based on the wake up command.

Aspect 27: The method of any of Aspects 18-26, further comprising providing, to the RU, a management plane message including an emergency wake-up indication associated with a transition, of a control plane processing component of the RU, from a sleep mode of the RU to an awake mode of the RU.

Aspect 28: The method of Aspect 27, wherein providing the management plane message comprises providing the management plane message during a sleep duration associated with the sleep mode of the RU.

Aspect 29: The method of any of Aspects 18-28, wherein the capability information explicitly indicates the at least one antenna set.

Aspect 30: The method of any of Aspects 18-29, wherein the capability information comprises a flag that indicates that each antenna element set of the plurality of antenna elements is a selectable antenna element set.

Aspect 31: The method of any of Aspects 18-30, wherein the RF channel reconfiguration command comprises a bitmap, each bit of the bitmap corresponding to a respective antenna element of the plurality of antenna elements.

Aspect 32: The method of any of Aspects 18-31, wherein the RF channel reconfiguration command corresponds to a set of time resources.

Aspect 33: The method of Aspect 32, wherein the slot level control plane configuration message indicates the set of time resources.

Aspect 34: The method of any of Aspects 1-17, wherein the slot level control plane configuration message comprises a spatial stream mute index having a value indicating at least one of a quantity of spatial streams to be muted, a quantity of spatial streams to remain active, a set of spatial stream identifiers (IDs) associated with a set of spatial streams to be muted, or a set of spatial stream IDs associated with a set of spatial streams to remain active.

Aspect 35: The method of any of Aspects 18-31, wherein the slot level control plane configuration message comprises a spatial stream mute index having a value indicating at least one of a quantity of spatial streams to be muted, a quantity of spatial streams to remain active, a set of spatial stream identifiers (IDs) associated with a set of spatial streams to be muted, or a set of spatial stream IDs associated with a set of spatial streams to remain active.

Aspect 36: An apparatus for wireless communication at a device, comprising a processor; one or more memories coupled with the processor; and instructions stored in the one or more memories and executable by the processor to cause the apparatus to perform the method of one or more of Aspects 1-17 and 34.

Aspect 35: A device for wireless communication, comprising one or more memories and one or more processors coupled to the one or more memories, the one or more processors configured to perform the method of one or more of Aspects 1-17 and 34.

Aspect 36: An apparatus for wireless communication, comprising at least one means for performing the method of one or more of Aspects 1-17 and 34.

Aspect 37: A non-transitory computer-readable medium storing code for wireless communication, the code comprising instructions executable by a processor to perform the method of one or more of Aspects 1-17 and 34.

Aspect 38: A non-transitory computer-readable medium storing a set of instructions for wireless communication, the set of instructions comprising one or more instructions that, when executed by one or more processors of a device, cause the device to perform the method of one or more of Aspects 1-17 and 34.

Aspect 39: An apparatus for wireless communication at a device, comprising a processor; one or more memories coupled with the processor; and instructions stored in the one or more memories and executable by the processor to cause the apparatus to perform the method of one or more of Aspects 18-33 and 35.

Aspect 40: A device for wireless communication, comprising one or more memories and one or more processors coupled to the one or more memories, the one or more processors configured to perform the method of one or more of Aspects 18-33 and 35.

Aspect 41: An apparatus for wireless communication, comprising at least one means for performing the method of one or more of Aspects 18-33 and 35.

Aspect 42: A non-transitory computer-readable medium storing code for wireless communication, the code comprising instructions executable by a processor to perform the method of one or more of Aspects 18-33 and 35.

Aspect 43: A non-transitory computer-readable medium storing a set of instructions for wireless communication, the set of instructions comprising one or more instructions that, when executed by one or more processors of a device, cause the device to perform the method of one or more of Aspects 18-33 and 35.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a radio unit (RU) for wireless communication, comprising:
providing, to a distributed unit (DU), capability information associated with at least one antenna element set, the at least one antenna element set comprising a set of antenna elements, of a plurality of antenna elements of the RU, configured for communication while the set of antenna elements is active;
obtaining, from the DU, a slot level control plane configuration message comprising a radio frequency (RF) channel reconfiguration command that indicates an antenna element set of the at least one antenna element set; and
communicating, based on the RF channel reconfiguration command, a wireless communication using the antenna element set.

2. The method of claim 1, further comprising providing, to the DU, a ready communication that indicates that the RU is ready to communicate data traffic, wherein communicating the wireless communication comprises communicating the wireless communication based on providing the ready communication.

3. The method of claim 1, further comprising:
providing, to the DU, sleep mode capability information indicating a set of defined sleep duration values supported by the RU; and
obtaining, from the DU and based on the sleep mode capability information, a management plane message including an indication of a subset of defined sleep duration values, of the set of defined sleep duration values, associated with a control plane processing component of the RU.

4. The method of claim 1, wherein the slot level control plane configuration message includes an indication of a deactivation of the antenna element set, the method further comprising:
providing to the DU, sleep mode capability information indicating a set of sleep modes supported by the RU, wherein the sleep mode capability information further indicates, for each sleep mode of the set of sleep modes, a respective associated wake-up time of a set of wake-up times, and wherein the indication of the deactivation of the antenna element set is associated with a sleep mode of the set of sleep modes;
obtaining, from the DU, an additional slot level control plane configuration message comprising a reactivate command associated with the antenna element set; and
reactivating, at a reactivation time and based on the reactivate command, the antenna element set.

5. The method of claim 4, wherein the sleep mode capability information indicates, for each wake-up time of the set of wake-up times, a value type, the value type comprising a definite value type or a minimum value type.

6. The method of claim 5, wherein the reactivation time corresponds to a wake-up time, of the set of wake-up times, associated with the sleep mode based on the sleep mode having the definite value type.

7. The method of claim 5, further comprising providing, to the DU and based on the sleep mode having the minimum value type, a ready communication that indicates that the RU is ready to communicate data traffic, wherein the reactivation time is based on a time associated with providing the ready communication.

8. The method of claim 1, further comprising:
obtaining, from the DU, a management plane message including an indication of an undefined sleep duration associated with a control plane processing component of the RU;
obtaining, from the DU, a wake up command associated with the control plane processing component of the RU; and
activating the control plane processing component based on the wake up command.

9. The method of claim 1, further comprising:
obtaining, from the DU, a management plane message including an emergency wake-up indication; and
transitioning a control plane processing component from a sleep mode to an awake mode based on the emergency wake-up indication.

10. The method of claim 9, wherein obtaining the management plane message comprises obtaining the management plane message during a sleep duration associated with the sleep mode.

11. The method of claim 1, further comprising:
activating, based on the RF channel reconfiguration command, each antenna element of the antenna element set; and
deactivating, based on the RF channel reconfiguration command, each antenna element of the plurality of antenna elements that is omitted from the antenna element set.

12. The method of claim 1, wherein the capability information explicitly indicates the at least one antenna set.

13. The method of claim 1, wherein the capability information comprises a flag that indicates that each antenna element set of the plurality of antenna elements is a selectable antenna element set.

14. The method of claim 1, wherein the RF channel reconfiguration command comprises a bitmap, each bit of the bitmap corresponding to a respective antenna element of the plurality of antenna elements.

15. The method of claim 1, wherein the RF channel reconfiguration command corresponds to a set of time resources, wherein the slot level control plane configuration message indicates the set of time resources.

16. The method of claim 1, further comprising receiving an indication of a group of beamforming weight values, each beamforming weight value of the plurality of beamforming weight values corresponding to a respective antenna element of the plurality of antenna elements, and wherein communicating the wireless communication comprises communicating the wireless communication based on a set of beamforming weights, of the group of beamforming weight values, corresponding to the set of antenna elements.

17. The method of claim 1, wherein the slot level control plane configuration message comprises a spatial stream mute index having a value indicating at least one of a quantity of spatial streams to be muted, a quantity of spatial streams to remain active, a set of spatial stream identifiers (IDs) associated with a set of spatial streams to be muted, or a set of spatial stream IDs associated with a set of spatial streams to remain active.

18. A method of wireless communication performed by a distributed unit (DU) for wireless communication, comprising:
obtaining, from a radio unit (RU), capability information associated with at least one antenna element set, the at least one antenna element set comprising a set of antenna elements, of a plurality of antenna elements of the RU, configured for communication while the set of antenna elements is active; and
providing, to the RU, a slot level control plane configuration message comprising a radio frequency (RF) channel reconfiguration command that indicates an antenna element set of the at least one antenna element set.

19. The method of claim 18, further comprising:
obtaining, from the RU, a ready communication that indicates that the RU is ready to communicate data traffic; and
communicating with the RU based on providing the ready communication.

20. The method of claim 18, further comprising providing, to the RU, a management plane message including an indication of quantity of wake-up durations associated with a control plane processing component of the RU.

21. The method of claim 18, further comprising:
obtaining, from the RU, sleep mode capability information indicating a set of defined sleep duration values supported by the RU; and
providing, to the RU and based on the sleep mode capability information, a management plane message including an indication of a subset of defined sleep duration values, of the set of defined sleep duration values, associated with a control plane processing component of the RU.

22. The method of claim 18, wherein the slot level control plane configuration message includes an indication of a deactivation of the antenna element set, the method further comprising:
obtaining from the RU, sleep mode capability information indicating a set of sleep modes supported by the RU, wherein the sleep mode capability information further indicates, for each sleep mode of the set of sleep modes, a respective associated wake-up time of a set of wake-up times, and wherein the indication of the deactivation of the antenna element set is associated with a sleep mode of the set of sleep modes;
providing, to the RU, an additional slot level control plane configuration message comprising a reactivate command associated with the antenna element set; and
reactivating, at a reactivation time and based on the reactivate command, the antenna element set.

23. The method of claim 22, wherein the sleep mode capability information indicates, for each wake-up time of the set of wake-up times, a value type, the value type comprising a definite value type or a minimum value type.

24. The method of claim 18, further comprising:
providing, to the RU, a management plane message including an indication of an undefined sleep duration associated with a control plane processing component of the RU;
providing, to the RU, a wake up command associated with the control plane processing component of the RU; and
activating the control plane processing component based on the wake up command.

25. The method of claim 18, further comprising providing, to the RU, a management plane message including an emergency wake-up indication associated with a transition, of a control plane processing component of the RU, from a sleep mode of the RU to an awake mode of the RU.

26. The method of claim 25, wherein providing the management plane message comprises providing the management plane message during a sleep duration associated with the sleep mode of the RU.

27. A radio unit (RU) for wireless communication, comprising:
one or more memories; and
one or more processors coupled to the one or more memories and configured to cause the RU to:
provide, to a distributed unit (DU), capability information associated with at least one antenna element set, the at least one antenna element set comprising a set of antenna elements, of a plurality of antenna elements of the RU, configured for communication while the set of antenna elements is active;
obtain, from the DU, a slot level control plane configuration message comprising a radio frequency (RF) channel reconfiguration command that indicates an antenna element set of the at least one antenna element set; and
communicate, based on the RF channel reconfiguration command, a wireless communication using the antenna element set.

28. The RU of claim 27, wherein the one or more processors are further configured to cause the RU to:
activate, based on the RF channel reconfiguration command, each antenna element of the antenna element set; and
deactivate, based on the RF channel reconfiguration command, each antenna element of the plurality of antenna elements that is omitted from the antenna element set.

29. A distributed unit (DU) for wireless communication, comprising:
one or more memories; and
one or more processors coupled to the one or more memories and configured to cause the DU to:
obtain, from a radio unit (RU), capability information associated with at least one antenna element set, the at least one antenna element set comprising a set of antenna elements, of a plurality of antenna elements of the RU, configured for communication while the set of antenna elements is active; and
provide, to the RU, a slot level control plane configuration message comprising a radio frequency (RF) channel reconfiguration command that indicates an antenna element set of the at least one antenna element set.

30. The DU of claim 29, wherein the one or more processors are further configured to cause the DU to:
obtain, from the RU, a ready communication that indicates that the RU is ready to communicate data traffic; and
communicate with the RU based on providing the ready communication.
